(19) United States
(12) Patent Application Publication
(10) Pub. No.: US 2011/0169751 A1
(43) Pub. Date: Jul. 14, 2011

(54) TOUCH SCREEN INPUT DEVICE

(76) Inventors: Sang Hwa Kim, Gyunggi-do (KR); Young Soo Oh, Gyunggi-do (KR); Jong Young Lee, Gyunggi-do (KR); Ho Joon Park, Seoul (KR)

(21) Appl. No.: 12/721,531

(22) Filed: Mar. 10, 2010

(30) Foreign Application Priority Data
Jan. 14, 2010 (KR) 10-2010-0003578

(51) Int. Cl. G06F 3/041

(52) U.S. Cl. 345/173

(57) ABSTRACT

Disclosed herein is a touch screen input device, including: a first transparent electrode applied on one side of a transparent film using a conductive polymer composition including a conductive polymer and a solvent; a second transparent electrode applied on one side of a transparent substrate using the conductive polymer composition or indium-tin oxide (ITO); and a first adhesive layer disposed between one side of the transparent film and one side of the transparent substrate which face each other, so as to attach the one side of the first transparent electrode and the one side of the second transparent electrode to each other. The conductive polymer composition can be used to form transparent electrodes of the touch screen input device because it has a surface resistance of 10˜1000Ω/□.

### CROSS REFERENCE TO RELATED APPLICATION

This application claims the benefit of Korean Patent Application No. 10-2010-0003578, filed Jan. 14, 2010, entitled “Input device of resistive touch screen”, which is hereby incorporated by reference in its entirety into this application.

### BACKGROUND OF THE INVENTION

1. Technical Field

The present invention relates to a touch screen input device.

2. Description of the Related Art

As various computers, electrical household appliances, and communication appliances are becoming digitalized and rapidly highly-functionalized, it is keenly required to realize portable displays. In order to realize the portable displays, electrode materials for the portable displays must be transparent and have low resistance, must exhibit high flexibility so that the portable displays are mechanically stable, and must have a thermal expansion coefficient similar to that of a substrate so as not to overheat apparatuses and not to cause a short circuit or a great change in resistance even at high temperatures.

Currently, transparent conductive oxide (TCO) electrodes, such as an indium-tin oxide (ITO) electrode, an antimony-tin oxide (ATO) electrode and the like, are chiefly being used as electrodes for displays. These transparent conductive oxide (TCO) electrodes are formed by sputtering, and the process used to form them is complicated and expensive. The problems of the indium-tin oxide (ITO) electrode, one of the transparent conductive oxide (TCO) electrodes, are as follows:

1. The ITO electrode is made of an inorganic material, and thus wide cracks may occur at the time of forming the same.

2. Indium, the main raw material of the ITO electrode, is a limited mineral resource and is being insufficiently supplied with the expansion of the market for flat display panels.

3. The ITO electrode is not easy to fabricate because its fabricating process is complicated and its characteristics are limited when it is applied to a film in order that it can be used in a touch screen.

In order to solve the above problems, research into alternatives to ITO has been conducted in various ways. Among these alternatives, conductive polymers have lately attracted considerable attention because they are flexible and cheap. Examples of the conductive polymers may include polyaniline, polypyrrol, polythiophene, and the like. A polyethylenedioxythiophene/polystyrene sulfonate (PEDOT/PSS) complex, which is one of polythiophene derivatives, was developed by Bayer Corp. (brand name: Baytron P), and has been frequently used in antistatic films. However, the PEDOT/PSS complex has a surface resistance of about 10⁵˜10⁹Ω/□, and thus cannot suffice as an alternative to ITO. Further, it was proposed in many research papers that a solvent, such as dimethylsulfoxide (DMSO), ethylene glycol, sorbitol or the like, be added to ITO to improve the conductivity thereof. However, the addition of the solvent to the ITO is also insufficient as an alternative to ITO, and rather allows the conductivity of ITO to be further deteriorated by a binder which is inevitably used during the filming process. Other conductive polymers also have the above problems.

Korean Patent No. 0692474 discloses a conductive polymer composition including polyethylenedioxythiophene (PEDOT), oxygen-containing organic compounds (excluding nitrogen-containing organic compounds), and the like. However, an adhesive polymer used to form a conductive layer is not disclosed and proposed in Patent No. 0692474.

Further, a transparent conductive film formed of the conductive polymer composition disclosed in Patent No. 0692474 has a surface resistance of 10000Ω/□ or less, but this conductive polymer composition also does not suffice as an alternative to ITO.

Therefore, it is required to develop a conductive polymer having low surface resistance, which is suitable for use in an electrode for displays.

### SUMMARY OF THE INVENTION

Accordingly, the present invention has been made to solve the above-mentioned problems, and the present invention provides a touch screen input device employing a transparent conductive polymer composition having low surface resistance.

An aspect of the present invention provides a touch screen input device, including: a first transparent electrode applied on one side of a transparent film using a conductive polymer composition including a conductive polymer and a solvent; a second transparent electrode applied on one side of a transparent substrate using the conductive polymer composition or indium-tin oxide (ITO); and a first adhesive layer disposed between one side of the transparent film and one side of the transparent substrate which face each other, so as to attach the one side of the first transparent electrode and the one side of the second transparent electrode to each other.

Here, the conductive polymer composition may further include a liquid crystal polymer or a liquid phase polymer.

Further, the touch screen input device may further include: a second adhesive layer disposed on the other side of the transparent substrate; and an image display device attached to the second adhesive layer.

Further, the touch screen input device may further include: a functional layer formed on the other side of the transparent film, the functional layer being selected from among a hard coating layer, an anti-finger (AF) layer, an anti-glare (AG) layer, an anti-reflection (AF) layer and combinations thereof.

Further, the touch screen input device may further include: a window plate attached to the other side of the transparent film by a third adhesive layer; and a functional layer formed on one side of the window plate, the functional layer being selected from among a hard coating layer, an anti-finger (AF) layer, an anti-glare (AG) layer, an anti-reflection (AF) layer and combinations thereof.

Further, one side of the transparent substrate or at least one side of the transparent film may be high-frequency-treated or primer-treated.

Further, the first transparent electrode or the second transparent electrode may have a bar type pattern, a lozenge pattern, a hexagonal pattern, an octagonal pattern or a trigonal pattern.

Further, the transparent substrate may be made of polyethylene terephthalate (PET), polycarbonate (PC), polymethylmethacrylate (PMMA), polyethylene naphthalate (PEN), polyether sulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (BOPS) containing a K resin, glass, or reinforced glass.

Further, the liquid crystal polymer or the liquid phase polymer may be an acrylic polymer, an epoxy polymer, an ester polymer, a urethane polymer, a carboxylic polymer or an amide polymer.

Further, the liquid crystal polymer or the liquid phase polymer may be added in an amount of 0.1 to 20 parts by weight based on the conductive polymer.

Further, the conductive polymer may be poly-3,4-ethylenedioxythiophene/polystyrene sulfonate (PEDOT/PSS), polyaniline, polyacetylene or polyphenylenevinylene.

Further, the conductive polymer composition may have a surface resistance of 10˜1000Ω/□.

Further, the liquid crystal polymer or the liquid phase polymer may be 1,4-bis[3-(acryloxyoxy)propyloxy]-2-methyl benzene.

Further, the solvent may be any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

Further, the conductive polymer composition may further include a secondary dopant.

Further, the secondary dopant may be at least one solvent selected from the group consisting of dimethylsulfoxide, N-methylpyrrolidone, N,N-dimethylformamide, and N-dimethylacetimide.

Further, the conductive polymer composition may further include a dispersion stabilizer.

Further, the dispersion stabilizer may be ethylene glycol or sorbitol.

Further, the conductive polymer composition may further include a binder, a surfactant or an anti-foamer.

Further, the first transparent electrode or the second transparent electrode may be formed by applying the conductive polymer composition onto one side of the transparent film or one side of the transparent substrate, preheating the applied conductive polymer composition at a temperature of 100˜150° C. for 5˜30 minutes, and then drying the preheated conductive polymer composition at a temperature of 50˜150° C. for 0.5˜30 minutes.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are sectional views of a touch screen input device according to preferred embodiments of the present invention; and

FIGS. 3 to 8 are plan views of a first transparent electrode or a second transparent electrode according to preferred embodiments of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

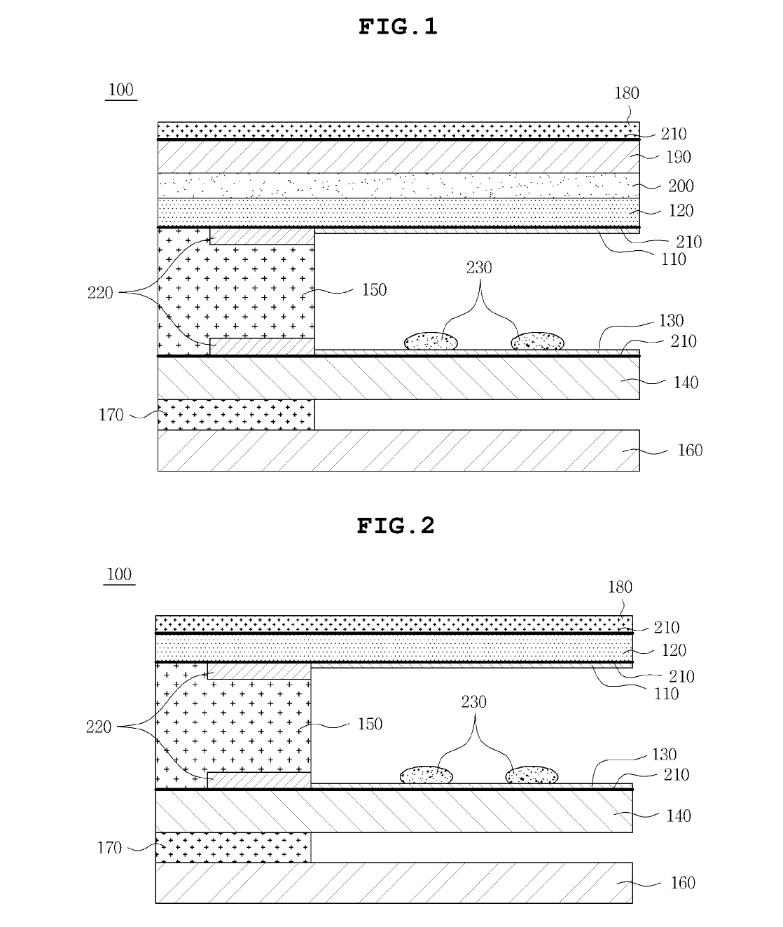

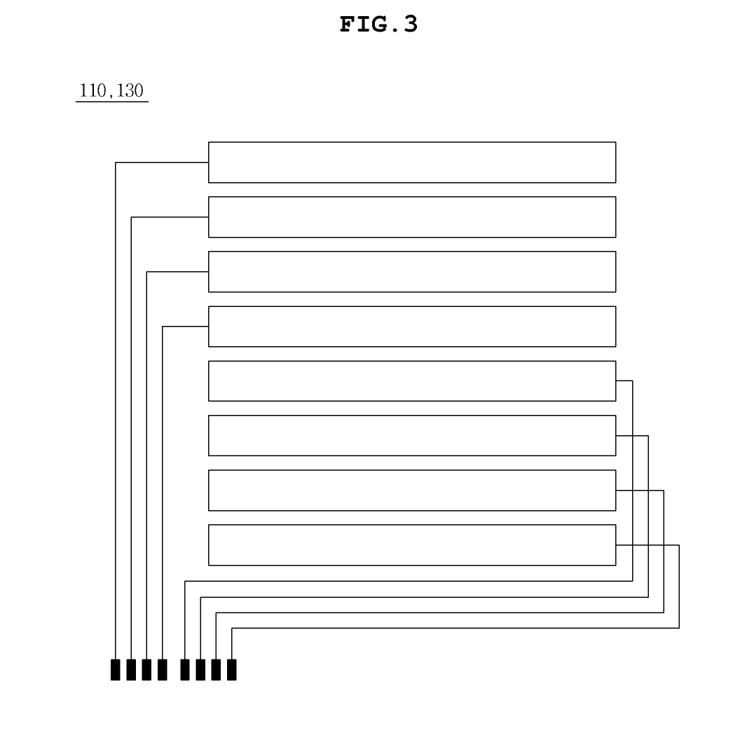

FIGS. 1 and 2 are sectional views of a touch screen input device according to preferred embodiments of the present invention.

As shown in FIGS. 1 and 2, a touch screen input device 100 according to an embodiment of the present invention includes: a first transparent electrode 110 applied on one side of a transparent film 120 using a conductive polymer composition including a liquid crystal polymer or liquid phase polymer, a conductive polymer and a solvent; a second transparent electrode 130 applied on one side of a transparent substrate 140 using the above conductive polymer composition or indium-tin oxide (ITO); and a first adhesive layer 150 disposed between one side of the transparent film 120 and one side of the transparent substrate 140 which face each other, so as to attach the one side of the first transparent electrode 110 and the one side of the second transparent electrode 130 to each other.

The transparent film 120 serves to receive the pressure of a user's body or a predetermined object. Further, one side of the transparent film 120 may be high-frequency-treated or primer-treated in order to improve adhesivity because one side of the transparent film 120 must be coated with the first transparent electrode 110.

The first transparent electrode 110 is applied on one side of the transparent film 120, and serves to allow a control unit to recognize pressed coordinates based on the voltage change occurring when the first transparent electrode 110 is brought into contact with the second transparent electrode 130 by the pressure applied to the transparent film 120. Here, the first transparent electrode 110 may be made of a conductive polymer composition including a liquid crystal polymer or a liquid phase polymer, a conductive polymer and a solvent. Detailed description of the conductive polymer composition will be explained later.

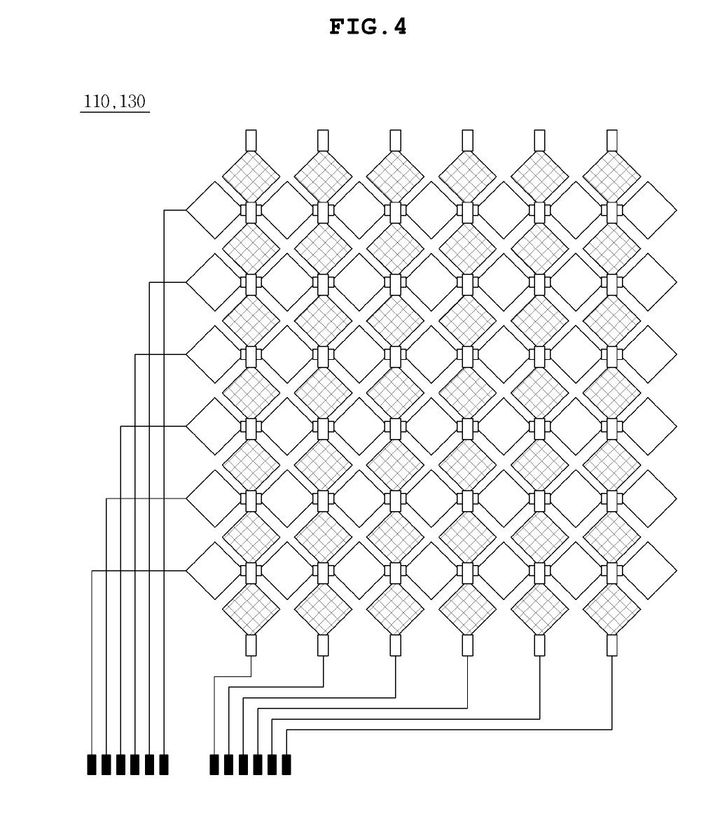

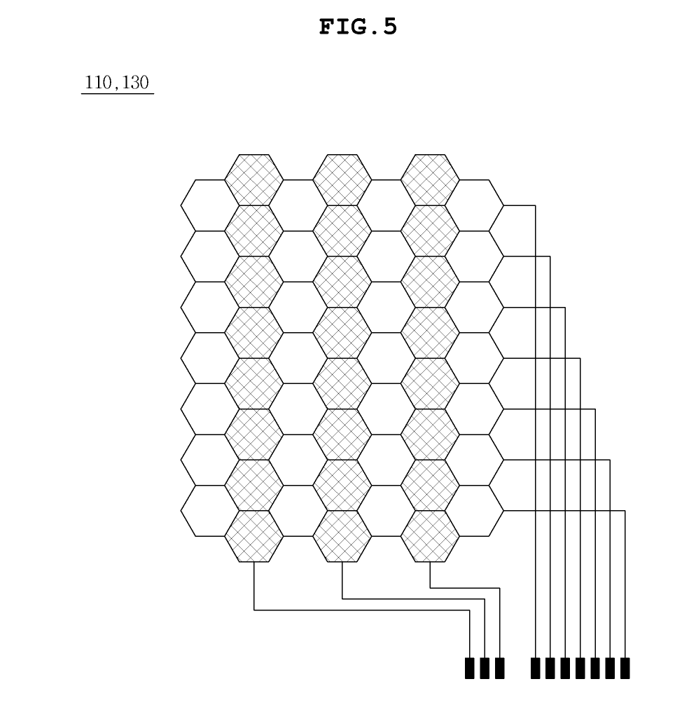

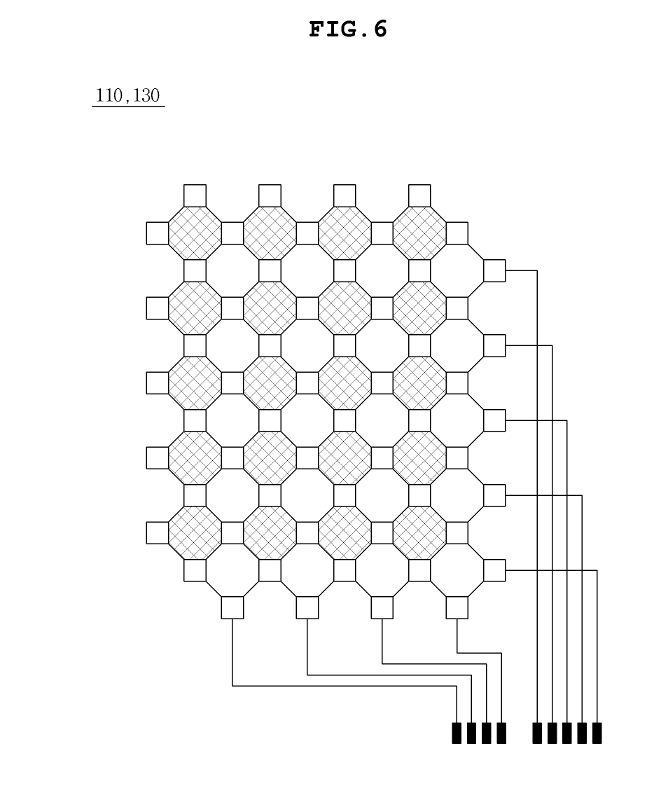

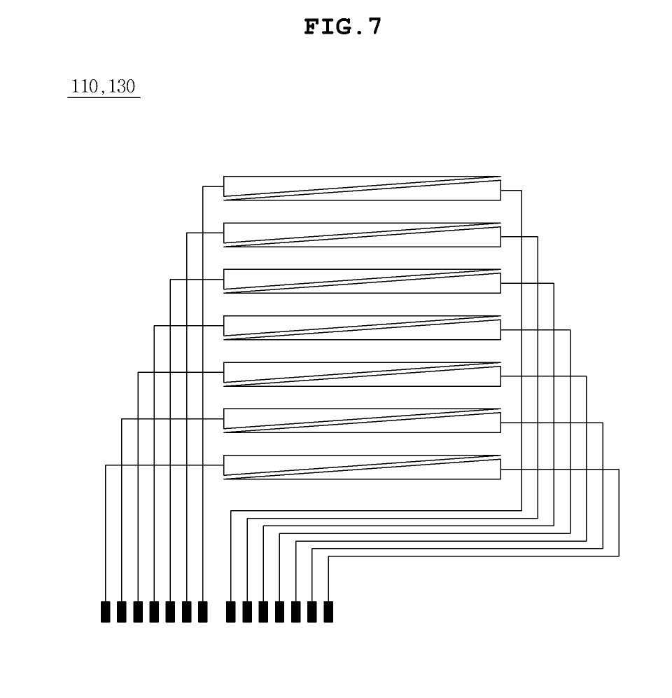

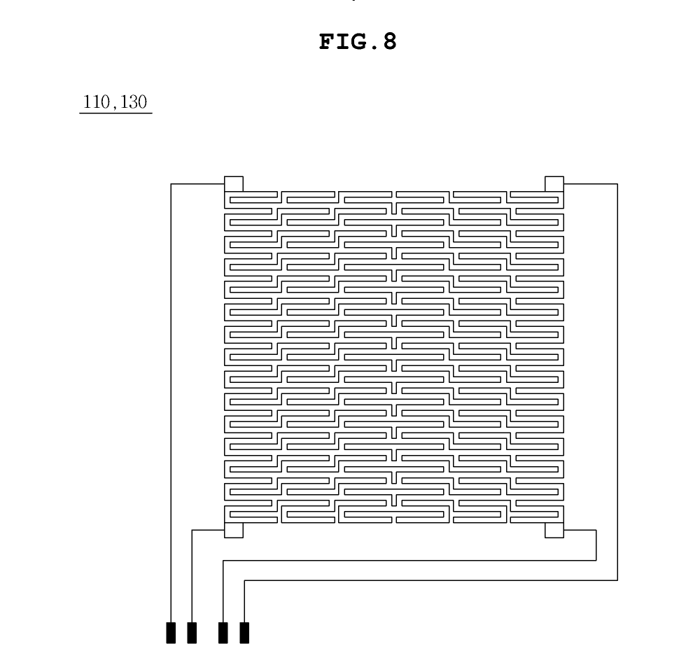

Meanwhile, in order to provide multifunction to the touch screen input device 100, the first transparent electrode 110 may have a bar type pattern (refer to FIG. 3), a lozenge pattern (refer to FIG. 4), a hexagonal pattern (refer to FIG. 5), an octagonal pattern (refer to FIG. 6) or a trigonal pattern (refer to FIG. 7). In addition to the above patterns, the first transparent electrode 110 may have various patterns (refer to FIG. 8) or may have no pattern.

The transparent substrate 140 is made of polyethylene terephthalate (PET), polycarbonate (PC), polymethylmethacrylate (PMMA), polyethylene naphthalate (PEN), polyether sulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (BOPS) containing a K resin, glass, reinforced glass or the like.

The second transparent electrode 130 is applied on one side of the transparent substrate 140, and serves to allow a control unit to recognize pressed coordinates based on the voltage change occurring when the first transparent electrode 110 is brought into contact with the second transparent electrode 130 by the pressure applied to the transparent film 120. Here, the second transparent electrode 130, the same as the first transparent electrode 110, may be made of a conductive polymer composition including a liquid crystal polymer or a liquid phase polymer, a conductive polymer and a solvent or may be made of indium-tin oxide (ITO). In this case, the second transparent electrode 130 may be formed on the transparent substrate 140 using a silk screen printing process, an ink jet printing process or the like. Further, one side of the transparent substrate 140 may be high-frequency-treated or primer-treated in order to improve adhesivity when the second transparent electrode 130 is applied on one side of the transparent electrode 140. Besides, when the second transparent electrode 130 is fabricated in the form of a film, it may be attached to the transparent substrate 140 using an optical clear adhesive (OCA).

Further, the second transparent electrode 130 is provided thereon with dot spacers 230. These dot spacers serve to reduce the impact occurring when the first transparent electrode 110 is brought into contact with the second transparent electrode 130, serve to provide repulsive force such that the first transparent electrode 110 returns to its original position when pressure is removed from the transparent film 120, and serve as insulators during normal time. Therefore, the dot spacers may have elasticity, and may be made of a transparent material such that images output from an image display device 160, which will be described later, are not blocked by these dot spacers 230. However, when the first transparent electrode 110 or the second transparent electrode 130 has durability and flexibility, the dot spacers may be made of a hard material.

Meanwhile, the second transparent electrode 130, the same as the first transparent electrode 110, may have a bar type pattern (refer to FIG. 3), a lozenge pattern (refer to FIG. 4), a hexagonal pattern (refer to FIG. 5), an octagonal pattern (refer to FIG. 6) or a trigonal pattern (refer to FIG. 7). In addition to the above patterns, the second transparent electrode 130 may have various patterns (refer to FIG. 8) or may have no pattern.

Further, electrodes 220 supplying voltage to the first transparent electrode 110 and the second transparent electrode 130 are printed at the edges of the first transparent electrode 110 and the second transparent electrode 130 using a silk screen printing process, a gravure printing process, an ink jet printing process or the like. In this case, the electrodes 220 may be made of silver (Ag) paste or organic silver having excellent electroconductivity, but are not limited thereto. The electrodes may be made of conductive polymers, carbon black (including CNTs), metal oxides such as ITO and the like, or metals having low resistance.

The first adhesive layer 150 serves to dispose the first transparent electrode 110 and the second transparent electrode 130 such that the first transparent electrode 110 and the second transparent electrode 130 face each other by attaching one side of the transparent film 120 coated with the first transparent electrode 110 to one side of the transparent substrate 140 coated with the second transparent electrode 130. Here, the first adhesive layer 150 is not particularly limited, but may be double-sided adhesive tape (DAT).

Meanwhile, an image display device 160 for outputting an image may be provided on the other side of the transparent substrate (the opposite side of the side coated with the second transparent electrode 130). Further, a second adhesive layer 170 may be interposed between the transparent substrate 140 and the image display device 160 in order to attach the image display device to the other side of the transparent substrate 140. Here, the image display device 160 may be a liquid crystal display (LCD) device, a plasma display panel (PDP), an electroluminescence (EL), a cathode ray tube (CRT) or the like, and the second adhesive layer 170, the same as the first adhesive layer 150, may be double-sided adhesive tape (DAT). Although not shown in drawings, an optical clear adhesive (OCA) film may be used in order to remove the air gap between the transparent substrate 140 and the image display device 160 to improve transparency.

Further, a window plate 190 for protecting the transparent film 120 and a functional layer 180 selected from among a hard coating layer, an anti-finger (AF) layer, an anti-glare (AG) layer, an anti-reflection (AF) layer and combinations thereof are sequentially provided on the other side of the transparent film 120 (the opposite side of the side coated with the first transparent electrode 110) (refer to FIG. 1). Here, a third adhesive layer 200 may be interposed between the transparent film 120 and the window plate 190 in order to attach the window plate 190 to the other side of the transparent film 120. In this case, the third adhesive layer 200 must be made of a transparent material such that users can recognize images output from the image display device 160, and, for example, an optical clear adhesive (OCA) film may be used as the third adhesive layer. Meanwhile, one side of the window plate 190 may be high-frequency-treated or primer-treated in order to improve adhesivity before the functional layer 180 is formed on one side of the window plate 190.

However, the window plate 190 is not necessarily provided on the other side of the transparent film 120, and, if necessary, a functional layer 180 selected from among a hard coating layer, an anti-finger (AF) layer, an anti-glare (AG) layer, an anti-reflection (AF) layer and combinations thereof is directly provided on the other side of the transparent film 120 (refer to FIG. 2).

Meanwhile, the other side of the transparent film 120 may be high-frequency-treated or primer-treated in order to improve adhesivity before the functional layer 180 is formed on the other side of the transparent film 120.

Hereinafter, a conductive polymer composition used in the touch screen input device 100 according to an embodiment of the present invention will be described in detail.

The conductive polymer composition according to an embodiment of the present invention, which serves as a binder and has improved conductivity properties, is characterized by a liquid crystal polymer or a liquid phase polymer having been introduced thereinto.

Therefore, the conductive polymer composition includes a liquid crystal polymer or a liquid phase polymer, a conductive polymer, and a solvent.

Here, the liquid phase polymer is a commonly-used transparent liquid adhesive serving as a binder, and the liquid crystal polymer is a compound exhibiting both liquid crystallinity and polymeric properties. A liquid crystal phase, which is an intermediate phase between a solid phase and a liquid phase, differently from the solid phase, has orientational order although it does not have a positional order, so that it exhibits intrinsic properties. Further, the liquid crystal phase is different from the liquid phase which has neither positional order nor orientational order.

As described above, since the liquid crystal polymer has orientational order as an intrinsic property, the liquid crystal polymer influences the form and arrangement of the conductive polymer when it is mixed with the conductive polymer composition after which such conductive polymer composition is applied. Therefore, due to the high order of the liquid crystal polymer or the liquid phase polymer, the order of the conductive polymer is also increased, and simultaneously the conductivity of a film prepared using this conductive polymer composition can be rapidly increased.

Generally, a dopant is used to improve the conductivity of the conductive polymer, but, even in this case, the conductivity of the conductive polymer can be improved only to such a degree that the surface resistance of the conductive polymer reaches 1000Ω/□. Further, a binder is inevitably used to impart film characteristics to the conductive polymer, but unavoidably deteriorates the surface resistance characteristics of the conductive polymer.

However, as in the present invention, when the liquid crystal polymer or the liquid phase polymer is added, the binder may not be used or can be used at a minimum, thus preventing the deterioration of the conductive properties of the conductive polymer.

The liquid crystal polymer or the liquid phase polymer can be used in polymer or monomer form. The liquid crystal monomer that is used may be an acrylic monomer, an epoxy monomer, an ester monomer, a urethane monomer, a carboxylic monomer or an amide monomer. For example, 1,4-bis[3-(acryloxyoxy)propyloxy]-2-methyl benzene (RM257, manufactured by Merck Corp.) or RM82, manufactured by Merck Corp., may be used as the liquid crystal monomer. Further, the liquid crystal monomer may be used independently or may be used after it is mixed with an isotropic monomer, such as 1,6-hexanediol diacrylate (HDDA), but the present invention is not limited thereto.

The conductive polymer that is used may be poly-3,4-ethylenedioxythiophene/polystyrene sulfonate (PEDOT/PSS), polyaniline, polyacetylene or polyphenylenevinylene, but is not limited thereto.

The liquid crystal polymer or the liquid phase polymer may be included in an amount of 0.1 to 20 parts by weight, preferably 5 to 10 parts by weight, based on the conductive polymer. When the amount of the liquid crystal polymer or the liquid phase polymer is less than 0.1 parts by weight, the effects of improving the conductivity and adhesivity attributable to the use of the liquid crystal polymer or the liquid phase polymer are slight. In contrast, when the amount thereof is more than 20 parts by weight, the amount of the conductive polymer and the amount of the solvent are relatively insufficient, thus deteriorating the conductive properties.

The conductive polymer composition of the present invention may be used after directly adding the liquid crystal polymer or the liquid phase polymer thereto, and may be used after it has been applied to a plastic substrate.

The conductive polymer film prepared using the conductive polymer composition of the present invention may have a surface resistance of 10˜1000Ω/□.

Examples of the binder used in the conductive polymer composition may include an acrylic binder, an epoxy binder, an ester binder, a urethane binder, an ether binder, a carboxylic binder, an amide binder and the like, and may be easily selected according to the kind of substrate that is used.

The solvent, which is a solvent used as a dispersant of the conductive polymer composition of the present invention, may be any one selected from among aliphatic alcohols, such as methanol, ethanol, i-propanol, butanol and the like; aliphatic ketones, such as acetone, methylethyl ketone and the like; aliphatic carboxylic acid esters; aliphatic carboxylic acid amides; aromatic hydrocarbons; aliphatic hydrocarbons; acetonitrile, aliphatic sulfoxides; water; and mixtures thereof.

Further, the conductive polymer composition of the present invention may further include a solvent as a secondary dopant in order to improve conductivity.

The solvent as a secondary dopant is one or more selected from the group consisting of dimethylsulfoxide, N-methylpyrrolidone, N,N-dimethylformamide, and N-dimethylacetimide.

Further, the conductive polymer composition of the present invention may further include a dispersion stabilizer. Ethylene glycol, sorbitol or the like may be used as the dispersion stabilizer.

Furthermore, the conductive polymer composition of the present invention may further include a binder, a surfactant, an anti-foamer or the like.

Meanwhile, the conductive polymer composition can be formed into a conductive polymer film having uniform conductivity, moisture resistance, heat resistance, durability and contractive stability by sufficiently drying the conductive polymer composition. In this case, the conductive polymer composition is dried at a temperature of 50˜150° C. and stays in a drying chamber for 0.5˜30 minutes. During the process of manufacturing a touch screen input device having an air gap, such as a resistive film type touch screen input device, the conductive polymer composition is preheated at a temperature of 100˜150° C. for 5˜30 minutes (heat-treated in a drying chamber) to improve the uniform conductivity, moisture resistance, heat resistance, durability and contractive stability of the conductive polymer film. In order to sufficiently dry the conductive polymer composition, the production rate of the conductive polymer film may be controlled, the length of drying lines may be increased, or the drying temperature of the conductive polymer composition may be controlled. In this case, the production rate of the conductive polymer film may be controlled using a gravure printing apparatus, a silk screen printing apparatus or an ink-jet printing apparatus, and the length of the drying lines may be increased by vertically crossing the drying lines. Meanwhile, the drying of the conductive polymer composition may be performed using thermal drying, UV drying or a combination thereof.

### Examples 1 to 6

The contents of components constituting a conductive polymer composition are given in Table 1 below. Here, the contents of the components are indicated by parts by weight based on the conductive polymer, that is, an aqueous PEDOT/PSS solution.

Additives were mixed with an aqueous PEDOT/PSS solution as a conductive polymer, and then stirred for about 1 hour to prepare a conductive polymer composition. The prepared conductive polymer composition was applied onto a transparent substrate, and then dried at a temperature of 50˜150° C. for 0.5˜30 minutes to form a conductive polymer thin film. The formed conductive polymer thin film had a thickness of 100˜200 nm and exhibited a transmissivity of 80% or more.

TABLE 1

| | | | | | | Liquid crys [symbol] |
|---|---|---|---|---|---|---|
| | Aqueous | | | | | polymer o [symbol] |
| | PEDOT | | | | Other | liquid phas [symbol] |
| | solution | Solvent | Dopant | Binder | additives | polymer |
| Example [symbol] | 28 | i-propanol | DMSO 1 | acyl 5 | <10 | 2 |
| | | 64 | | | | |
| Example [symbol] | 28 | i-propanol | DMSO 1 | PVA 5 | <10 | 2 |
| | | 64 | | | | |
| Example [symbol] | 28 | i-propanol | DMSO 1 | — | <10 | 7 |
| | | 64 | | | | |
| Example [symbol] | 28 | i-propanol | DMSO 1 | acyl 5 | <10 | 2 |
| | | 64 | | | | |
| Example [symbol] | 28 | i-propanol | DMSO 1 | acyl 5 | <10 | 2 |
| | | 64 | | | | |
| Example [symbol] | 28 | i-propanol | DMSO 2 | acyl 5 | <10 | — |
| | | 64 | | | | |

[symbol]

indicates data missing or illegible when filed

### Comparative Examples 1 and 2

Conductive polymer films were obtained using the same method as in Examples 1 to 6, except that the conductive polymer compositions given in Table 2 below were used.

In Comparative Example 1, the conductive polymer composition, differently from the conductive polymer composition of the present invention, does not include a liquid crystal polymer or a liquid phase polymer. In Comparative Example 2, the conductive polymer composition includes 25 parts by weight of a liquid crystal polymer or a liquid phase polymer, which deviates from the preferred range of adding the liquid crystal polymer of the present invention which is 0.1˜20 parts by weight.

TABLE 2

| | | | | | Liquid crys [symbol] |
|---|---|---|---|---|---|
| | Aqueous | | | | polymer o [symbol] |
| | PEDOT | | | | liquid phas [symbol] |
| | solution | Solvent | Dopant | Binder | polymer |
| Comp. | 28 | i-propanol | DMSO | acryl | — |
| Exp. 1 | | 64 | 1 | 5 | |
| Comp. | 28 | i-propanol | DMSO | acryl | 25 |
| Exp. 2 | | 42 | 1 | 5 | |

[symbol]

indicates data missing or illegible when filed

The surface resistance values of the conductive polymer films according to Examples 1 to 6 and Comparative Examples 1 and 2 are given in Table 3 below.

TABLE 3

| | Surface resistance ((Ω/□) | Adhesivity |
|---|---|---|
| Example 1 | 70 | good |
| Example 2 | 100 | good |
| Example 3 | 10 | good |
| Example 4 | 500 | good |
| Example 5 | 150 | good |
| Example 6 | 700 | good |
| Comp. Exp. 1 | 10,000 | good |
| Comp. Exp. 2 | 2,000 | good |

As given in Table 3, it can be seen that all of the conductive polymer films formed using the conductive polymer composition have a low surface resistance of 10˜1000Ω/□.

However, as in Comparative Example 1, when the liquid crystal polymer or the liquid phase polymer was not added, it can be seen that the conductive polymer film formed using the conductive polymer composition has a surface resistance of 10000Ω/□. Therefore, the conductive polymer composition according to Comparative Example 1 is not suitable as an alternative to ITO.

Further, as in Comparative Example 2, when the liquid crystal polymer or the liquid phase polymer was excessively added in an amount of more than 20 parts by weight, it can be seen that the conductive polymer film formed using the conductive polymer composition has a surface resistance of 2000Ω/□. Further, it can be seen that the conductive polymer composition according to Comparative Example 2 has a relatively high surface resistance compared to the conductive polymer composition according to the present invention. Therefore, it can be seen that the conductive polymer composition according to the present invention is more suitable for use in electrodes for displays as an alternative of ITO.

However, as in Example 6, even when the liquid crystal polymer or the liquid phase polymer was not added to the conductive polymer composition due to the addition of other additives such as a solvent, a dispersion stabilizer, a binder, a surfactant, an anti-foamer and the like, it can be seen that the conductive polymer films formed using the conductive polymer composition has a low surface resistance of 700Ω/□ or less. Therefore, it is possible to realize a conductive polymer film having desired surface resistance even when the liquid crystal polymer or the liquid phase polymer is not added. However, when the liquid crystal polymer or the liquid phase polymer is added, the surface resistance of the conductive polymer film can be further decreased.

As described above, the conductive polymer composition according to the present invention, differently from conventional conductive polymers, can prevent the deterioration of conductive properties by using a minimum of binder or by not using any binder at all.

Further, the conductive polymer film prepared using the conductive polymer composition according to the present invention can be used in transparent electrodes for resistive film type touch screen input devices, capacitance type touch screen input devices and various display devices because it has a low surface resistance of 10˜1000Ω/□.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A touch screen input device, comprising:
a first transparent electrode applied on one side of a transparent film using a conductive polymer composition including a conductive polymer and a solvent;
a second transparent electrode applied on one side of a transparent substrate using the conductive polymer composition or indium-tin oxide (ITO); and
a first adhesive layer disposed between one side of the transparent film and one side of the transparent substrate which face each other, so as to attach the one side of the first transparent electrode and the one side of the second transparent electrode to each other.

2. The touch screen input device according to claim 1, wherein the conductive polymer composition further includes a liquid crystal polymer or a liquid phase polymer.

3. The touch screen input device according to claim 1, further comprising:
a second adhesive layer disposed on the other side of the transparent substrate; and
an image display device attached to the second adhesive layer.

4. The touch screen input device according to claim 1, further comprising: a functional layer formed on the other side of the transparent film, the functional layer being selected from among a hard coating layer, an anti-finger (AF) layer, an anti-glare (AG) layer, an anti-reflection (AF) layer and combinations thereof.

5. The touch screen input device according to claim 1, further comprising:
a window plate attached to the other side of the transparent film by a third adhesive layer; and
a functional layer formed on one side of the window plate, the functional layer being selected from among a hard coating layer, an anti-finger (AF) layer, an anti-glare (AG) layer, an anti-reflection (AF) layer and combinations thereof.

6. The touch screen input device according to claim 1, wherein one side of the transparent substrate or at least one side of the transparent film is high-frequency-treated or primer-treated.

7. The touch screen input device according to claim 1, wherein the first transparent electrode or the second transparent electrode has a bar type pattern, a lozenge pattern, a hexagonal pattern, an octagonal pattern or a trigonal pattern.

8. The touch screen input device according to claim 1, wherein the transparent substrate is made of polyethylene terephthalate (PET), polycarbonate (PC), polymethylmethacrylate (PMMA), polyethylene naphthalate (PEN), polyether sulfone (PES), a cyclic olefin copolymer (COC), a triacetylcellulose (TAC) film, a polyvinyl alcohol (PVA) film, a polyimide (PI) film, polystyrene (PS), biaxially oriented polystyrene (BOPS) containing a K resin, glass, or reinforced glass.

9. The touch screen input device according to claim 1, wherein the liquid crystal polymer or the liquid phase polymer is an acrylic polymer, an epoxy polymer, an ester polymer, a urethane polymer, a carboxylic polymer or an amide polymer.

10. The touch screen input device according to claim 1, wherein the liquid crystal polymer or the liquid phase polymer is added in an amount of 0.1 to 20 parts by weight based on the conductive polymer.

11. The touch screen input device according to claim 1, wherein the conductive polymer is poly-3,4-ethylenedioxythiophene/polystyrene sulfonate (PEDOT/PSS), polyaniline, polyacetylene or polyphenylenevinylene.

12. The touch screen input device according to claim 1, wherein the conductive polymer composition has a surface resistance of 10˜1000Ω/□.

13. The touch screen input device according to claim 1, wherein the liquid crystal polymer or the liquid phase polymer is 1,4-bis[3-(acryloxyoxy)propyloxy]-2-methyl benzene.

14. The touch screen input device according to claim 1, wherein the solvent is any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

15. The touch screen input device according to claim 1, wherein the conductive polymer composition further includes a secondary dopant.

16. The touch screen input device according to claim 15, wherein the secondary dopant is at least one solvent selected from the group consisting of dimethylsulfoxide, N-methylpyrrolidone, N,N-dimethylformamide, and N-dimethylacetimide.

17. The touch screen input device according to claim 1, wherein the conductive polymer composition further includes a dispersion stabilizer.

18. The touch screen input device according to claim 17, wherein the dispersion stabilizer is ethylene glycol or sorbitol.

19. The touch screen input device according to claim 1, wherein the conductive polymer composition further includes a binder, a surfactant or an anti-foamer.

20. The touch screen input device according to claim 1, wherein the first transparent electrode or the second transparent electrode is formed by applying the conductive polymer composition onto one side of the transparent film or one side of the transparent substrate, preheating the applied conductive polymer composition at a temperature of 100˜150° C. for 5˜30 minutes, and then drying the preheated conductive polymer composition at a temperature of 50˜150° C. for 0.5˜30 minutes.
